(19) United States
(12) Patent Application Publication
(10) Pub. No.: US 2023/0117509 A1
(43) Pub. Date: Apr. 20, 2023

(54) CROSS MEMBER AND SUSPENSION AND STEERING UNIT USING SAME

(71) Applicant: George Maron Ferris, II, Hollywood, FL (US)

(72) Inventor: George Maron Ferris, II, Hollywood, FL (US)

(21) Appl. No.: 17/504,218

(22) Filed: Oct. 18, 2021

(51) Int. Cl. B62D 25/08; B60G 7/02

(52) U.S. Cl. CPC B62D 25/082; B62D 25/088; B60G 7/02; B60G 2204/143

(57) ABSTRACT

A replacement steering and suspension support cross member is configured to replace the original cross member in an automobile that, as originally designed, could only receive small block motors into its engine bay, so that a big block motor can be installed in the engine bay. The cross member has first and second end portions that are joined, longitudinally, by a central portion. The central portion is recessed from the front and top of the end portions. The assembly further includes upper and lower control arms at each end as well as shock supports. The cross member is configured to reside at a transverse position that is behind the position of the original cross member, while the spindle mounts and shock absorber mounts are offset forward to be on the original axle axis.

### FIELD OF THE INVENTION

The present invention relates generally to an automotive front end suspension, and, more particularly, relates to a front end suspension and steering system that allows the installation of big block motors in classic vehicles originally built to accommodate only small block motors.

### BACKGROUND OF THE INVENTION

There is a strong interest in restoring and rebuilding what are referred to as “classic” automobiles. These are automobiles originally built in the 1950s through the mid-1970s. Of particular interest in the United States are “muscle” cars, which refers to automobiles any of several models of 2-door coupe automobiles with V-8 engines made from the mid-1960s until the energy crisis of the 1970s, which caused people to favor more fuel efficient automobiles. But currently, there is a substantial market for classic muscle cars, either restored to their original condition or modified with larger engines or more modern components.

One of the automobile models that is of particular interest among collectors and other classic muscle car enthusiasts is the Ford Mustang, which was originally produced in 1964 for the 1965 model year, and continues to be produced today. The original 1965 and 1966 models were available with a 289 cubic inch V-8 motor. Beginning in 1967, however, elements of the vehicle were redesigned to accommodate larger motors. In fact, in 1967 Ford offered the Mustang with a 390 cubic inch V-8 motor. This motor came to be known as the “Big Block” motor while the 289 cubic inch motor was dubbed the “Small Block” motor. Reproductions of both motors are available today and made by aftermarket manufacturers. However, the 1965-66 Mustangs, as originally designed, will not accommodate the Big Block motor. The Big Block motor is too wide to fit between the original shock tower, and the cross bar under the engine that joins the chassis rails and support the steering and front suspension components interferes with the oil pan of the Big Block motor. Others have solved this problem by moving the position of the wheels forward, and cutting and re-fabricating the fender wells, or alternatively, using a second generation Mustang (Mustang II) front end. However, this approach substantially modifies the body, and is disfavored by many enthusiasts who prefer keeping the body as close to original as possible.

Therefore, a need exists to overcome the problems with the prior art as discussed above.

### SUMMARY OF THE INVENTION

In accordance with some embodiments of the inventive disclosure, there is provided a replacement steering and suspension support cross member for an automobile to allow a larger than original motor to be mounted in an engine bay of the automobile, the automobile having a frame including a first front frame rail and a second front frame rail on opposite lateral sides of the engine bay along a bottom of the engine bay, the automobile having an original front axle axis. The replacement steering and suspension cross member includes a longitudinal body having a first end portion and a second end portion opposite the first end portion, a central portion disposed between the first end portion and second end portion, a top and a front of the central portion being recessed relative to a top and a front of the first and second end portions. The longitudinal body further includes a first lower frame support attached at a distal end of the first end portion and on the top of the first end portion, a second lower frame support attached at a distal end of the second end portion and on the top of the second end portion, wherein the first lower frame support is configured to mate with a bottom of the first front frame rail, and the second lower frame support is configured to mate with a bottom of the second front frame rail. The longitudinal body further includes a first side frame support positioned on the top of the first end portion adjacent the first lower frame support and extending above the first frame support, a second side frame support positioned on the top of the second end portion adjacent the second lower frame support and extending above the second frame support, wherein the first side frame support is configured to mate with the first front frame rail at in inner side of the first front frame rail and the second side frame support is configured to mate with the second front frame rail at in inner side of the second front frame rail.

In accordance with a further feature, the replacement steering and suspension support cross member further includes a first upper shock support attached to a top of the first side frame support and having a first shock hole configured for receiving and mounting an upper end of a first shock absorber, a second upper shock support attached to a top of the second side frame support and having a second shock hole configured for receiving and mounting an upper end of a second shock absorber, and wherein first and second shock holes are vertically positioned over an axis along the front of the first and second end portions.

In accordance with a further feature, the replacement steering and suspension support cross member further includes a first upper control arm mounted on the first upper shock support and having a first upper spindle mount, a second upper control arm mounted on the second upper shock support and having a second upper spindle mount, and wherein the first upper spindle mount and the second upper spindle mount are vertically positioned over the axis along the front of the first and second end portions.

In accordance with a further feature, the replacement steering and suspension support cross member further includes a first lower control arm mounted on the first end portion and having a first lower shock support having a first opening configured to receive a lower end of the first shock absorber and having a first lower spindle mount, a second lower control arm mounted on the second end portion and having a second lower shock support having a second opening configured to receive a lower end of the second shock absorber and having a second lower spindle mount, wherein the first spindle mount and the second spindle mount are vertically positioned along the axis along the front of the first and second end portions.

In accordance with a further feature, the longitudinal body has a length of about thirty inches.

In accordance with a further feature, the first end portion and the second end portion each have a length of about ten inches.

In accordance with a further feature, the central portion has a length of about nine and three quarter inches.

In accordance with a further feature, the replacement steering and suspension support cross member further includes a first standoff extending from a back side of the first end portion, a second standoff extending from the back side of the second end portion, and a steering actuator mounted transversely on the first and second standoffs.

In accordance with a further feature, the automobile is a first generation Ford Mustang.

In accordance with some embodiments of the inventive disclosure, there is provided a method for modifying a classic automobile having an engine bay, original lower cross member, and original shock towers that were designed to accept a small block motor and not accept a big block motor. The method includes removing the original cross member and the original shock towers. The method further includes providing a replacement steering and suspension cross member having a longitudinal body that includes a first end portion and a second end portion opposite the first end portion, a central portion disposed between the first end portion and second end portion, a top and a front of the central portion being recessed relative to a top and a front of the first and second end portions. The method further includes providing the longitudinal body with a first lower frame support attached at a distal end of the first end portion and on the top of the first end portion, a second lower frame support attached at a distal end of the second end portion and on the top of the second end portion, wherein the first lower frame support is configured to mate with a bottom of a first front frame rail, and the second lower frame support is configured to mate with a bottom of a second front frame rail. The method further includes providing the longitudinal body with a first side frame support positioned on the top of the first end portion adjacent the first lower frame support and extending above the first frame support, a second side frame support positioned on the top of the second end portion adjacent the second lower frame support and extending above the second frame support, wherein the first side frame support is configured to mate with the first front frame rail at in inner side of the first front frame rail and the second side frame support is configured to mate with the second front frame rail at in inner side of the second front frame rail. The method further includes welding the first bottom frame support and first side frame support to the first front frame rail, and welding the second bottom frame support and second side frame support to the second front frame rail.

Although the invention is illustrated and described herein as embodied in a cross member and a suspension and steering unit that allows installation of a big block motor into the engine bay of a vehicle originally designed only to accommodate small block motors, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. In general these terms of approximation indicate a range of ±10% can be assumed unless otherwise indicated for any dimensional units. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the element being referenced. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1A is a top plan view of a cross member for a steering and suspension unit that is configured to allow installation of a big block motor into an engine bay of a vehicle originally designed only to fit a small block motor, in accordance with some embodiments;

FIG. 1B is a front elevational view of a cross member for a steering and suspension unit that is configured to allow installation of a big block motor into an engine bay of a vehicle originally designed only to fit a small block motor, in accordance with some embodiments;

FIG. 1C is a perspective view of a cross member for a steering and suspension unit that is configured to allow installation of a big block motor into an engine bay of a vehicle originally designed only to fit a small block motor, in accordance with some embodiments;

FIG. 2A is a top plan view of the cross member with frame supports, in accordance with some embodiments;

FIG. 2B is a front elevational view of the cross member with frame supports, in accordance with some embodiments;

FIG. 3A is a top plan view of the cross member with upper shock supports, in accordance with some embodiments;

FIG. 3B is a front elevational view of the cross member with upper shock supports, in accordance with some embodiments;

FIG. 4A is a top plan view of the cross member with frame supports and lower control arms attached, in accordance with some embodiments;

FIG. 4B is a front elevational view of the cross member with frame supports and lower control arms attached, in accordance with some embodiments;

FIG. 5A is a top plan view of the cross member with upper shock supports and upper control arms attached, in accordance with some embodiments;

FIG. 5B is a front elevational view of the cross member with upper shock supports and upper control arms attached, in accordance with some embodiments;

FIG. 6 is a top plan view of the cross member with the steering unit attached, in accordance with some embodiments;

FIG. 7 is a top-front perspective view of the engine bay of an automobile, with the engine removed;

FIG. 8A is a elevational view of a side wall of the engine bay of the automobile with the shock tower in place and the front frame rail exposed;

FIG. 8B is a elevational view of a side wall of the engine bay of the automobile with the shock tower removed and the front frame rail exposed;

FIG. 9 shows a front side view of the suspension and steering unit installed and attached to a section of the front frame of the vehicle, in accordance with some embodiments;

FIG. 10 shows a top plan view of the suspension and steering unit installed in the vehicle, and showing the outline of an oil pan of a big block engine, in accordance with some embodiments; and

FIG. 11 shows a side view through a cross section of the cross member showing the bottom boundary of the oil pan of a big block engine when installed in the engine bay of the vehicle with the suspension and steering unit installed, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient cross member for a suspension and steering unit for an automobile. In particular, the cross member is configured to replace an original cross member of an automobile, along with suspension and steering components that are mounted on the cross member, and allow the installation of a big block motor into the engine bay of the vehicle which was not originally designed to accommodate a big block motor. For example, the first generation Ford Mustang was designed to accommodate only a small block motor and not the subsequently produced big block motors. The small block motor is a V-8 motor having 289 cubic inches of displacement, and as used herein the term shall be understood to refer to that motor as made and sold by Ford, Inc. as of 1966. In the second generation of the Mustang, Ford re-designed the engine bay and components to accommodate a big block motor that is a V-8 motor having 390 cubic inches of displacement. Ford then subsequently developed the 428 Cobra Jet motor which had 428 cubic inches of displacement and was first build in 1968. As used herein the term “big block” shall be understood to refer to either the 390 cubic inch or the 428 cubic inch motors as made and sold by Ford, Inc. as of 1967 and 1968, respectively, or similarly large motor that would not fit into the engine bay of a first generation Mustang as originally designed (i.e. unmodified). Classic car enthusiasts have had a desire to install big block motors in first generation Mustangs, but this presents certain issues with clearance since the first generation was not designed to accommodate the big block motor. The inventive cross member replaces the original cross member and provides the necessary clearance without requiring moving the front wheels forward, as is the case with existing aftermarket cross member and suspension and steering units.

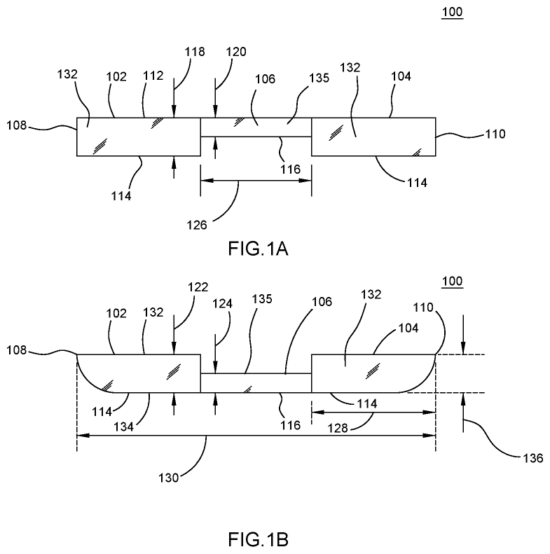

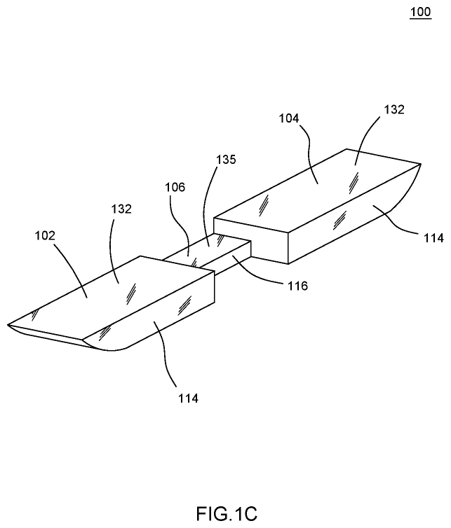

FIG. 1A is a top plan view of a cross member 100 for a steering and suspension unit that is configured to allow installation of a big block motor into an engine bay of a vehicle originally designed only to fit a small block motor, in accordance with some embodiments. FIG. 1B is a front elevational view of the cross member 100, and FIG. 1C is a perspective view of the cross member 100. The cross member 100 is a generally longitudinal member having an overall length 130 from end to end (from 108 to 110) that is long enough to span between the front frame rails of the automobile and fit under each of the front frame rails at the same time, as well as support the control arms and suspension components in the wheel wells. Thus, the cross member 100 has a longitudinal body that spans from the outer side of one front frame rail to the outer side of the other front frame rail at the bottom of each front frame rail. The outer sides of the front frame rails are those sides facing outward from the engine bay, toward the respective wheel wells. The cross member 100 includes several portions 102, 104, and 106. Portions 102 and 104 are first and second end portions on opposite ends of the cross member 100 while portion 106 is a central portion that connects the opposing end portions 102, 104. Each of the portions 102, 104, 106 can be generally rectangular, and made of rectangular tube steel. The cross member 100 can be fabricated from a single rectangular tube steel member having the width 118 and height 136 of the first and second end portions 102, 104, and the center portion 106 can be formed by cutting out a section of the tubing, folding the cut out portion over to create a smaller tube section and welding the folded portion onto the existing tube section. Cover plates can then be welded onto the inner ends of the end portions 102, 104 that are exposed in the process of creating the central portion 106 in this way. It is also contemplated that the cross member 100 can be fabricated in other ways, such as by forging, casting, and other methods known to those skilled in the art of metal fabrication.

First end portion 102 and second end portion 104 are each generally elongated having a length 128 that is greater than their width 118, and the three cross member portions 102, 104, 106 are arranged in the elongated direction from the distal end 108 of the first end portion 102 to the opposite distal end 110 of the second end portion 104. The end portions 102, 104 have a top side or surface 132, a front side 114, a back side 112, and a bottom 134. The central portion 106 has a top side 135, and a front side 116, and shares the back side 112 and bottom 134 with the end portions 102, 104. The central portion 106 has a width 120 that is narrower than the width 118 of the end portions 102, 104, as the front side 116 of the central portion 106 is set back from the front side 114 of the end portions 102, 104. The front side 116 of the central portion is recessed or behind the front side 114 of the first and second end portions 102, 104, and the top side 135 of the central portion is below the top side 132 of the first and second end portions 102, 104. Accordingly, the central portion 106 is recessed relative to the front and top sides of the first and second end portions. The back sides and bottom sides of the central portion 106 and the end portions 102, 104 can be common and coplanar. As a result, there is space in front of and over the central portion 106, which as will be shown, that provides clearance for the oil pan of the big block motor. The height 124 of the central portion 106 is less than that (136) of the end portions 102, 104 such that the top side 135 of the central portion 106 is below that (132) of the end portions 102, 104, which also provides necessary clearance for the oil pan of the big block motor.

The overall length 130 of the cross member, from end 108 to end 110, can be about thirty inches (29¾″). The length 128 of the end portions 102, 104, from each distal end 108, 110 to where the respective end portion 102, 104 meets the central portion, can be about ten inches (10″), and the length 126 of the central portion, between the end portions 102, 104, can be about nine and three quarters inches (9¾″). The width 118 of the end portions 102, 104 from the front side 114 to the back side 112 can be about four inches (4″), and the height 136 of the end portions 102, 104 from the bottom 134 to the top 132 can be about three inches (3″). The width of the central portion 106 can be about two inches (2″) and its height 124 can be about one and one half inches (1½″). In some embodiments the bottom side 134 can be rounded or angled up to the distal ends 108, 110 at the top 132 side as shown. Thus, the cross member 100 has a generally elongated body including opposing end portions 102, 104 on opposite ends of the central portion 106. The end portions 102, 104 can have a similar or equal height and width, with their front, back, top, and sides being respectively coplanar, while the top 135 and the front 116 of the central portion 106 are recessed relative to that of the side portions 102, 104.

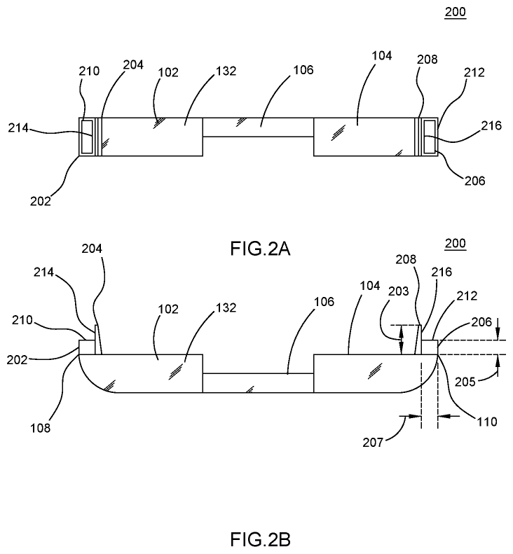

FIG. 2A is a top plan view of the cross member 200 with frame supports, in accordance with some embodiments, and FIG. 2B is a front elevational view of the cross member 200 with frame supports. That is, shown in FIGS. 2A-2B is the cross member 100 with frame supports added, thereby modifying cross member 100 to become cross member 200. The frame supports are structures on top side 132 of the end portions 102, 104 adjacent the distal ends 108, 110 that are configured to engage the bottom and inner sides of the frame rails. The frame support structures include a lower frame support 202, 206 on the top 132 of each end portion 102, 104 adjacent the respective distal ends 108, 110. Importantly, the lower frame supports 202, 206 are each positioned to engage the bottom of a respective front frame rail, so their position on the cross member 100 is less related to the distal ends 108, 110 than to the distance between frame rails, which, in a first generation Mustang, is about twenty six inches. Adjacent each of the lower frame supports 202, 206 are side frame supports 204, 208, which extend upward above a top 210, 212 of the lower frame supports 202, 206. The side frame supports 204, 208 are configured to be in contact with the side of the respective frame rails when the lower frame supports 202, 206 are positioned in contact with the bottom of the respective frame rails. Once in position, the top 210, 212 of the lower frame supports can be welded to the bottom of the respective frame rails, and the frame-facing sides 214, 216 of the side frame supports 204, 208 can be welded to the sides of the respective frame rails. The lower frame supports 202, 206 can have a height 205 of about two inches (2″), and a length 207 of about two inches (2″), and a width that is equal to that of the end portions 102, 104 of the cross member 100. The lower frame supports 202, 206 can be section of rectangular tubing used to fabricate the cross member 100 that are cut to have the required height 205 and then welded to the top side 132 of the end portions 102, 104. The side frame supports 204, 208 present a wall that can be reinforced such as by forming them in a wedge shape, having a wider base at the top side 132 of the end portions 102, 104 than at the top of the side frame supports 204, 208. The side frame supports can have a height 203 of five and one half inches (5½″), which is about three and one half inches higher than the height 205 of the lower frame supports 202, 206. In general, the height 205 of the lower frame supports 202, 206, and the difference in height between the top 135 of the central portion 106 and the top side 132 of the end portions 102, 104 is such that the oil pan of the big block motor will fit over, and in front of the central portion 106 of the cross member. The height and width of the end portions 102, 104 and central portion are selected based on the material being used to fabricate the cross member in order to have sufficient structural rigidity when the cross member is welded in place to the frame rails.

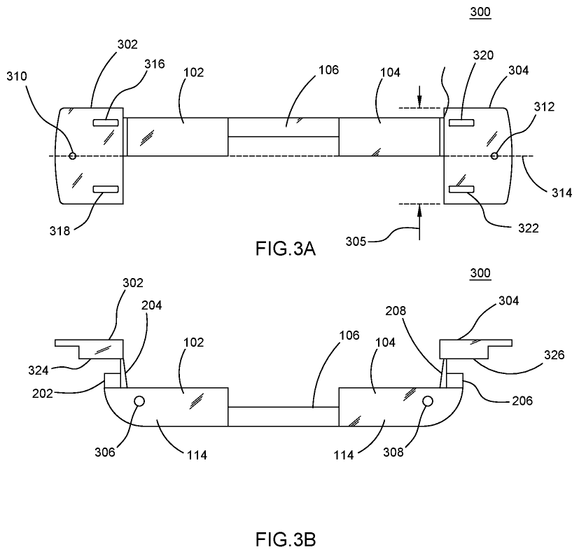

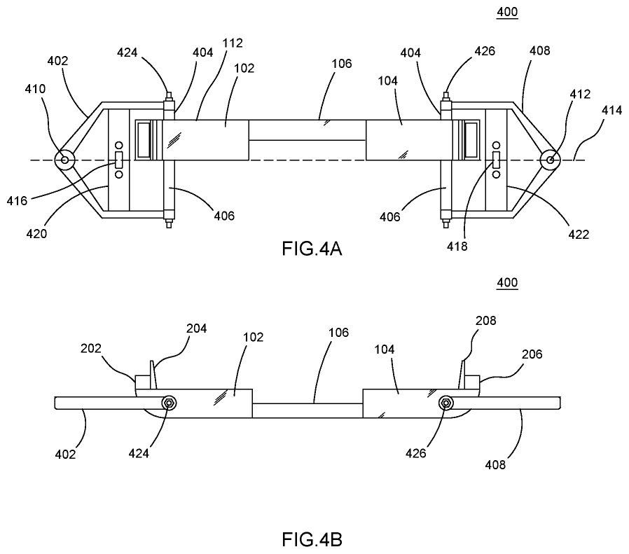

FIG. 3A is a top plan view of the cross member 300 with upper shock supports, in accordance with some embodiments, and FIG. 3B is a front elevational view of the cross member 300 with upper shock supports. Building further on the structure of FIGS. 2A-2B, upper shock supports 302 and 304 are shown attached to the top of side frame supports 204, 208. The upper shock supports 302, 304 each have shock hole 310, 312 for receiving the top of a respective shock absorber and damper unit. As shown, the shock holes 310, 312 are vertically positioned over axis 314, which represents an axial line along the front of the end portions 102, 104, which is between the original front axles of the vehicle, along which the original cross member was located. Accordingly, it can be seen that the inventive replacement cross member 100 is positioned, when attached to the front frame rails, behind this axis 314 such that the front 114 of the first and second end portions 102, 104 is along the original axle axis. The upper shock supports 302, 304 can have a width 305 of about seven inches to eight and one half inches (7″-8½″), which can be about twice that of the width of the end portions 102, 104 or more. The upper shock supports 302, 304 can be welded to the top of the side frame supports 204, 208, and have a bottom side 324, 326 that can be attached/welded to the tops of the respective front frame rails. Accordingly, the structure is attached to each of the frame rails on three sides of the frame rails, which will be located in the spaces between the lower frame supports 202, 206 and the upper shock supports 302, 304. Holes 306, 308 are provided through the end portions 102, 104 at the front side 114 through the back side. These holes 306, 308 are for mounting of the lower control arms and lower shock supports, as will be shown in FIGS. 4A-4B. The first upper shock support 302 further includes a pair of upper control arm mounting openings 316, 318 on which the first upper control arm 502 is mounted. Likewise, the second upper shock support 304 includes a pair of upper control arm mounting openings 320, 322 on which the second upper control arm 508 is mounted.

FIG. 4A is a top plan view of the cross member 400 with frame supports and lower control arms attached, in accordance with some embodiments, and FIG. 4B is a front elevational view of the cross member 400 with frame supports and lower control arms attached. A first lower control arm 402 is mounted on a rod 424 through the end portion 102 (e.g. through hole 306), using bushings 404, 406. Likewise, a second control arm 408 is mounted on end portion 104 with a rod 426 through the end portion 104 (e.g. hole 308) with bushings 404, 406. Bushing 406 is substantially longer to occupy the longer offset distance between the end portions 102, 104 and the front connector of the lower control arms 402, 408. The lower control arms 402, 408 each have a lower spindle mount 410, 412 in which the vertical spindle for the front wheel hub is mounted. The lower spindle mounts 410, 412, like the shock holes 310, 312 in the upper shock supports 302, 304, are aligned on an axis 414 at the front, or in front of, the front of the end portions 102, 104, which can be the original axial line between the front axles. The rods 424, 426 and bushings 404, 406 allow the lower control arms 402, 408 to pivot about the axis of the rods 424, 426. Each of the lower control arms 402, 408 also have a lower shock support 420, 422 in which the lower end of the shock absorber/damper unit is mounted, such as in openings 416, 418, respectively. Thus, while the upper shock supports 302, 304 are fixed to the frame rails, the movement of the lower control arms 402, 408 will allow for compression of the shock absorbers.

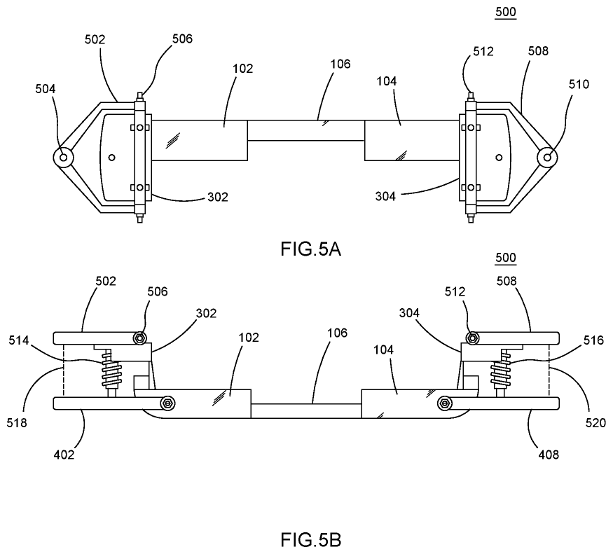

FIG. 5A is a top plan view of the cross member 500 with upper shock supports and upper control arms attached, in accordance with some embodiments, and FIG. 5B is a front elevational view of the cross member 500 with upper shock supports and upper control arms attached. That is, in FIGS. 5A-5B all of the components through FIGS. 4A-4B are shown, with the addition of upper control arms 502, 508, and shock absorber/damper units 514, 516. The upper control arms 502, 508 are mounted on the top of the upper shock supports 302, 304 on axial rods 506, 512. Each of the upper control arms 502, 508 have a respective upper spindle mount 504, 510 that corresponds to the lower spindle mounts 410, 412 as indicated by broken lines 518, 520, respectively. The shock absorber/damper units 514, 516 are mounted between the upper and lower shock supports 302, 420 and 304, 422. The upper control arms 502, 508 will pivot up and down with the lower control arms 402, 408, and will move outside of the upper shock supports 302, 304.

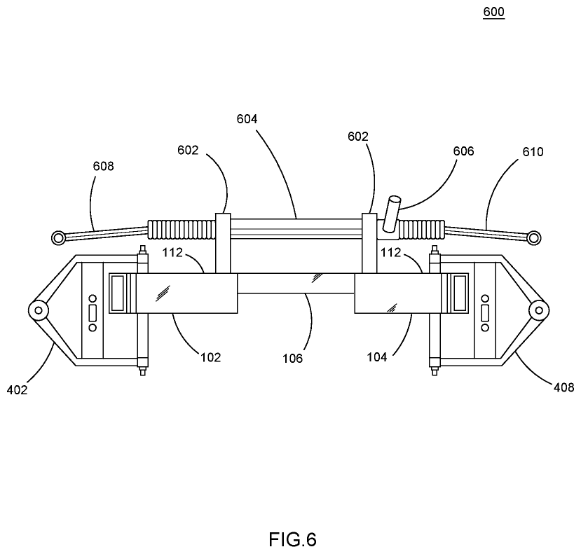

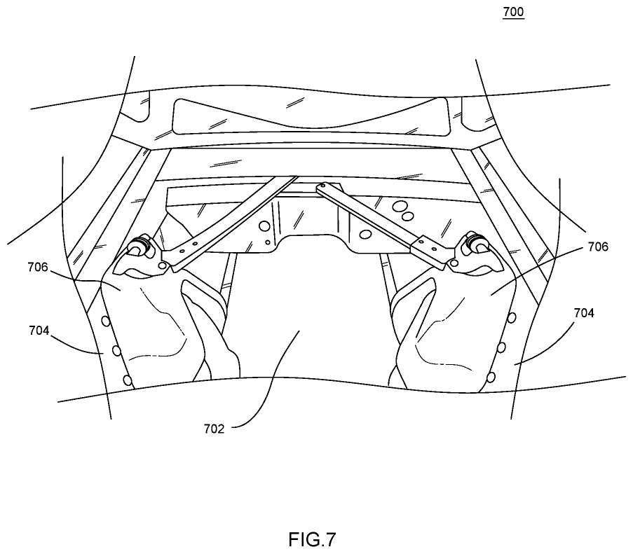

FIG. 6 is a top plan view of the cross member 600 with the steering unit attached, in accordance with some embodiments. In this view the upper shock supports 302, 304 and the upper control arms 502, 508 are not shown. A pair of standoffs 602 are shown attached to the back side 112 of the end portions 102, 104 near the center portion 106 to hold the steering actuator 604. The steering actuator 604 is driven by steering input coupling 606 that is connected to the steering wheel, and moves steering arms 608, 610 in unison. The steering arms 608, 610 are further connected to steering linkage on the wheel hubs, as is well known. The standoffs 602 can be welded to the back side 112 of the end portions 102, 104, and provide mounting structures to mount the steering actuator 604 therein and hold is securely.

FIG. 7 is a top-front perspective view 700 of the engine bay 702 of an automobile, with the engine removed. Specifically, the automobile is a 1966 Ford Mustang. On either side of the engine bay 702 are the side panels 704, and mounted on the side panels are the original shock towers 706. The original cross member has been removed. To install the suspension and steering unit with the inventive cross member, the original shock towers 706 must be removed. Likewise, the original cross member must be removed as it is responsible for preventing a big block motor from fitting into the engine bay 702.

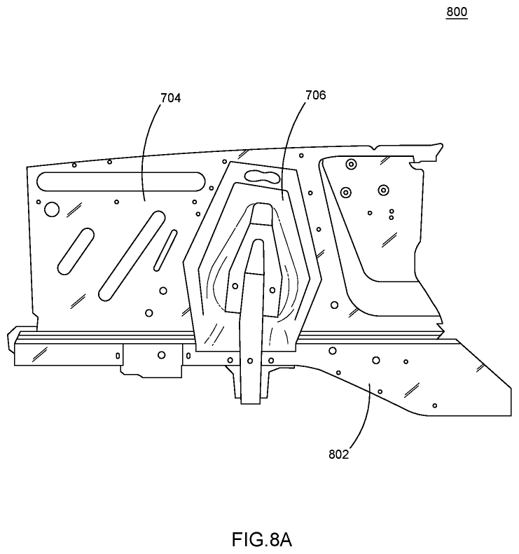

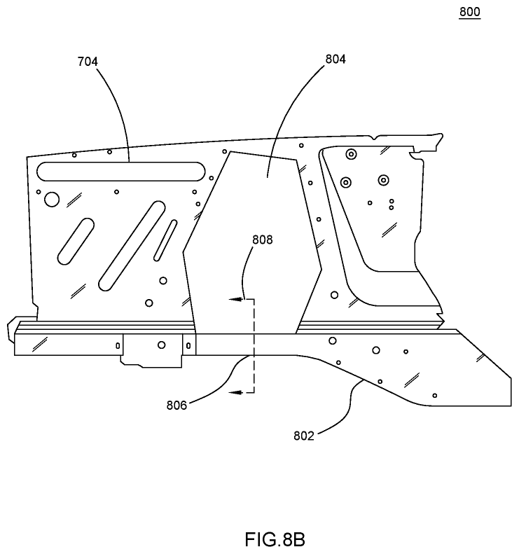

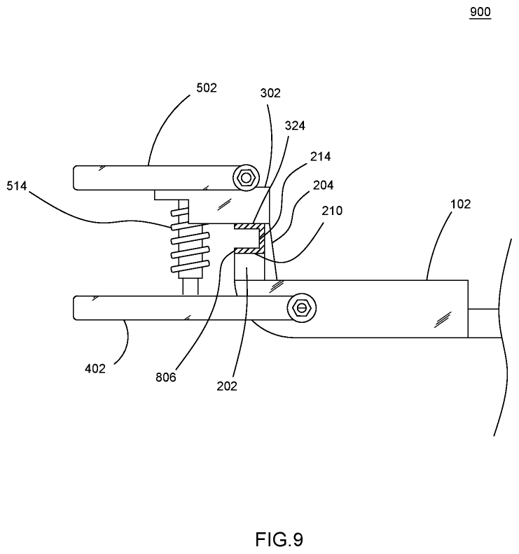

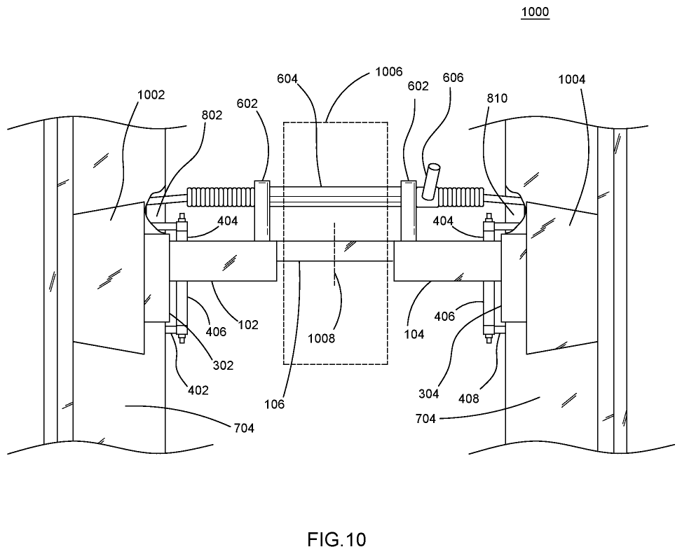

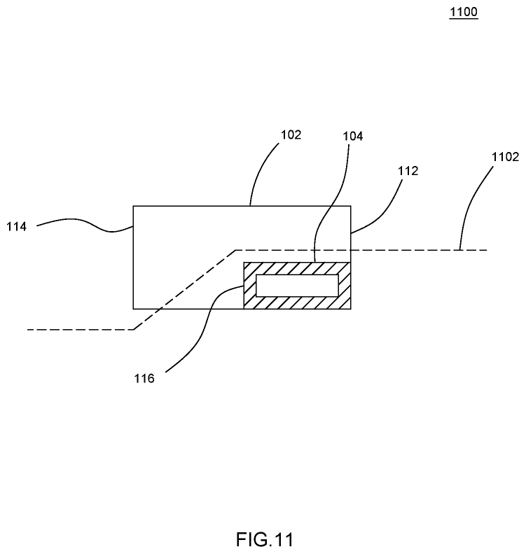

FIG. 8A is a elevational view of a side wall 800 of the engine bay of the automobile with the shock tower in place and the front frame rail 802 exposed, and FIG. 8B is a elevational view of a side wall 800 of the engine bay of the automobile with the shock tower removed and the front frame rail 802 exposed. The side view shown there is taken from inside the engine bay looking at the right side of the engine bay. The left side of the engine bay would be substantially a mirror image of that shown here. As mentioned, to install the suspension and steering unit with the inventive cross member, the shock towers 706 much be removed, exposing opening 804 through the side panel 704 and exposing a portion 806 of the front frame rail 802. The section line 808 indicates the cross section of the expose front frame rail that is cut through in FIG. 9. FIG. 9 shows a front side view of the suspension and steering unit installed and attached to a section 806 of the front frame rail 802 of the vehicle, in accordance with some embodiments. As can be seen in FIG. 9, the bottom of the frame rail is on the top 210 of the lower frame support 202, the side of the frame rail is against the side frame support 204, and the top of the frame rail 802 is against the bottom 324 of the upper shock support 302. All of these contact points are welded to attach the suspension and steering unit to the frame rail. The upper and lower control arms 502, +++ extend through the opening 804 in the side panel 704 of the engine bay into the front wheel well so that the front wheel hub can be mounted on the upper and lower control arms 502, +++. Unlike other aftermarket cross members or modification kits to allow a big block motor to be installed in the engine bay, the inventive cross member is designed so that the front wheels can be kept in their original location, rather than having to be moved forward, necessitating substantial body work to move the fenders and wheel wells. FIG. 10 shows a top plan view 1000 of the suspension and steering unit installed in the vehicle, and showing the outline 1006 of an oil pan of a big block engine, in accordance with some embodiments. Plates 1002 and 1004 are used to cover the openings (e.g. 804) created by removal of the shock towers 706. A section line 1008 through the central portion shows where a section cut is take for the view of FIG. 11, which shows a side view 1100 through the cross section (1008) of the central portion 106 of the cross member showing the bottom boundary 1102 of the oil pan of a big block engine when installed in the engine bay of the vehicle with the suspension and steering unit installed, in accordance with some embodiments. In the view of FIG. 11 it can be seen that if the cross member were coaxially mounted on the axle line (e.g. 414) that there would not be clearance to accommodate the original oil pan of the big block motor.

The claims appended hereto are meant to cover all modifications and changes within the scope and spirit of the present invention.

What is claimed is:

1. A replacement steering and suspension support cross member for an automobile to allow a larger than original motor to be mounted in an engine bay of the automobile, the automobile having a frame including a first front frame rail and a second front frame rail on opposite lateral sides of the engine bay along a bottom of the engine bay, the automobile having an original front axle axis, the replacement steering and suspension cross member comprising:
a longitudinal body having a first end portion and a second end portion opposite the first end portion, a central portion disposed between the first end portion and second end portion, a top and a front of the central portion being recessed relative to a top and a front of the first and second end portions;
a first lower frame support attached at a distal end of the first end portion and on the top of the first end portion, a second lower frame support attached at a distal end of the second end portion and on the top of the second end portion, wherein the first lower frame support is configured to mate with a bottom of the first front frame rail, and the second lower frame support is configured to mate with a bottom of the second front frame rail; and
a first side frame support positioned on the top of the first end portion adjacent the first lower frame support and extending above the first frame support, a second side frame support positioned on the top of the second end portion adjacent the second lower frame support and extending above the second frame support, wherein the first side frame support is configured to mate with the first front frame rail at in inner side of the first front frame rail and the second side frame support is configured to mate with the second front frame rail at in inner side of the second front frame rail.

2. The replacement steering and suspension support cross member of claim 1, further comprising:
a first upper shock support attached to a top of the first side frame support and having a first shock hole configured for receiving and mounting an upper end of a first shock absorber;
a second upper shock support attached to a top of the second side frame support and having a second shock hole configured for receiving and mounting an upper end of a second shock absorber; and
wherein first and second shock holes are vertically positioned over an axis along the front of the first and second end portions.

3. The replacement steering and suspension support cross member of claim 2, further comprising:
a first upper control arm mounted on the first upper shock support and having a first upper spindle mount;
a second upper control arm mounted on the second upper shock support and having a second upper spindle mount; and
wherein the first upper spindle mount and the second upper spindle mount are vertically positioned over the axis along the front of the first and second end portions.

4. The replacement steering and suspension support cross member of claim 3, further comprising:
a first lower control arm mounted on the first end portion and having a first lower shock support having a first opening configured to receive a lower end of the first shock absorber and having a first lower spindle mount;
a second lower control arm mounted on the second end portion and having a second lower shock support having a second opening configured to receive a lower end of the second shock absorber and having a second lower spindle mount; and
wherein the first spindle mount and the second spindle mount are vertically positioned along the axis along the front of the first and second end portions.

5. The replacement steering and suspension support cross member of claim 1, wherein the longitudinal body has a length of about thirty inches.

6. The replacement steering and suspension support cross member of claim 1, wherein the first end portion and the second end portion each have a length of about ten inches.

7. The replacement steering and suspension support cross member of claim 1, wherein the central portion has a length of about nine and three quarter inches.

8. The replacement steering and suspension support cross member of claim 1, further comprising:
a first standoff extending from a back side of the first end portion;
a second standoff extending from the back side of the second end portion; and
a steering actuator mounted transversely on the first and second standoffs.

9. The replacement steering and suspension support cross member of claim 1, wherein the automobile is a first generation Ford Mustang.

10. A method for modifying a classic automobile having an engine bay, original lower cross member, and original shock towers that were designed to accept a small block motor and not accept a big block motor, the method comprising:
removing the original cross member and the original shock towers;
providing a replacement steering and suspension cross member comprising:
a longitudinal body having a first end portion and a second end portion opposite the first end portion, a central portion disposed between the first end portion and second end portion, a top and a front of the central portion being recessed relative to a top and a front of the first and second end portions;
a first lower frame support attached at a distal end of the first end portion and on the top of the first end portion, a second lower frame support attached at a distal end of the second end portion and on the top of the second end portion, wherein the first lower frame support is configured to mate with a bottom of a first front frame rail, and the second lower frame support is configured to mate with a bottom of a second front frame rail;
a first side frame support positioned on the top of the first end portion adjacent the first lower frame support and extending above the first frame support, a second side frame support positioned on the top of the second end portion adjacent the second lower frame support and extending above the second frame support, wherein the first side frame support is configured to mate with the first front frame rail at in inner side of the first front frame rail and the second side frame support is configured to mate with the second front frame rail at in inner side of the second front frame rail;
welding the first bottom frame support and first side frame support to the first front frame rail; and
welding the second bottom frame support and second side frame support to the second front frame rail.
